(19) United States
(12) Patent Application Publication
(10) Pub. No.: US 2019/0160439 A1
(43) Pub. Date: May 30, 2019

(54) COMPOSITE PARTICLE MANUFACTURING DEVICE AND COMPOSITE PARTICLE MANUFACTURING METHOD

(71) Applicant: National University Corporation TOYOHASHI UNIVERSITY OF TECHNOLOGY, Aichi-ken (JP)

(72) Inventors: Hiroyuki MUTO, Aichi-ken (JP); Atsushi YOKOI, Aichi-ken (JP); Naoto KIMURA, Aichi-ken (JP); GO KAWAMURA, Aichi-ken (JP); Atsunori MATSUDA, Aichi-ken (JP)

(73) Assignee: National University Corporation TOYOHASHI UNIVERSITY OF TECHNOLOGY, Aichi-ken (JP)

(21) Appl. No.: 16/320,865

(22) PCT Filed: Jul. 27, 2017
(86) PCT No.: PCT/JP2017/027224

§ 371 Date: Jan. 25, 2019

(30) Foreign Application Priority Data
Jul. 28, 2016 (JP) 2016-149072

(51) Int. Cl. B01F 3/20; B01F 3/18; B01L 3/00

(52) U.S. Cl. CPC B01F 3/2035; B01F 2003/0042; B01L 3/5027; B01F 3/188

(57) ABSTRACT

[Problem] To provide a device for manufacturing composite particles constructed by flow paths having relatively great widths and capable of controlling an adsorption ratio of particles, and to provide a method for manufacturing composite particles using this manufacturing device.

[Solution] A device for manufacturing composite particles includes at least one first inlet flow path (2) for supplying a first fluid, at least one second inlet flow path (3) for supplying a second fluid, and a mixing flow path (5) for merging the first fluid and the second fluid supplied respectively from the first inlet flow path and the second inlet flow path and allowing the two kinds of fluids to flow down for a predetermined length while mixing the two kinds of fluids. The mixing flow path is a continuous flow path and has a heterogeneous cross-sectional flow path area in a continuity direction thereof.

### TECHNICAL FIELD

The present invention relates to a device for manufacturing composite particles comprising a plurality of particles, and a manufacturing method using the device.

### BACKGROUND ART

The present inventors have studied a method for manufacturing composite particles by electrostatic adsorption so far and developed reasonably-constructed manufacturing devices (See Patent Documents 1 and 2). The abovementioned method for manufacturing composite particles is to induce positive surface charge potential of one of two kinds of particles and negative surface charge potential of the other kind of particles, and cause the two kinds of particles to be electrostatically attracted and adsorbed onto each other.

In this respect, the invention disclosed in Patent Document 1 is a technique to compound a variety of particles by coating particles dispersed in liquid with a polymer electrolyte and thus controlling surface charge potential of the particles to have a positive or negative value. The invention disclosed in Patent Document 2 is a technique to optimize the amount of a polymer electrolyte added for the abovementioned surface charge potential control and thus facilitate the control of surface potential of the particles.

Using these techniques, surface charge potential of particles to be compounded can be controlled to have a positive or negative value, and composite particles can be produced by mixing these positively or negatively charged particles. Moreover, composite particles having a variety of physical and other properties can be produced by changing a mixing ratio of these particles. In this case, composite particles in which particles are compounded at a desired ratio are produced by mixing two kinds of fluids separately containing positively or negatively charged particles while changing the volume of the two kinds of fluids and thus adjusting relative amounts of the positively and negatively charged particles mixed. One example of this is a method for manufacturing a composite particle slurry applied for patent by the applicant of the present invention under Japanese Patent Application No. 2016-024261. A manufacturing device used in this case, however, has some room for improvement in flow path structure because a flow path need not only to have an extremely great length but also to be meandered.

By the way, there is a method for mixing two kinds of fluids respectively containing two kinds of particles in a microsized flow path (See Patent Document 3). This mixing method, however, aims only to mix a fluid containing microparticles having positive surface potential and a fluid containing microparticles having negative surface potential in a microsized flow path, and has been developed to fabricate what are called core-shell composite particles. That is to say, this mixing method is incapable of manufacturing composite particles in which a relative ratio of two kinds of particles adsorbed is changed.

### CITATION LIST

### Patent Literature

[PTL 1] Japanese Unexamined Patent Application Publication No. 2010-64945

[PTL 2] Japanese Re-publication of PCT International Publication No. 2012-133696

[PTL 3] Japanese Unexamined Patent Application Publication No. 2006-82073

### SUMMARY OF INVENTION

### Technical Problem

As mentioned above, the technique disclosed in Patent Document 3 is to simply produce composite particles by mixing two kinds of fluids in a microsized flow path and a preferred width of the microsized flow path is set to be less than 100 μm. Such limitation of the flow path width is determined because when the microsized flow path width is 100 μm or greater, electrostatic adsorption of the two kinds of particles becomes poor. One possible reason for this is that a greater flow path width may fail to bring the two kinds of particles contained in the two kinds of fluids in vicinity of each other and leave some particles electrostatically unadsorbed.

Moreover, this technique does not change a relative ratio of the two kinds of particles electrically adsorbed. One possible reason for this is difficulty in flow rate control due to the extremely small flow path width. For example, suppose that one kind of particles are mother particles and the other kind of particles are child particles and that composite particles in which a ratio of the child particles adsorbed on surfaces of the mother particles is changed are to be produced. In such a case, the number of child particles to be adsorbed need to be controlled with respect to the number of mother particles, but since supply of fluid to a micronized flow path accompanies a great discharge pressure, it is not easy to control flow rates of the fluids by controlling the discharge pressure. If particle concentrations in the fluids are changed instead of changing the flow rates, a relative ratio of the two kinds of particles adsorbed shall be changed, but it is not easy to precisely change the particle concentrations in the fluids. Consequently, a change in ratio of the two kinds of particles adsorbed (control of the absorption ratio into a desired one) has practically not been achieved so far.

Furthermore, when composite particles are produced using a microsized flow path, part of the particles sometimes remain in the flow path and these remnant particles sometimes clog up the flow path. In order to solve this problem, fluid containing no particles is passed to remove the remnant particles. This act, however, cannot completely remove the remnant particles and the microsized flow path is sometimes unusable due to clogging. As a result, productivity is poor and efficient mass production of composite particles has been difficult. An increase in flow path width may avoid clogging, but still leaves the problem of poor electrostatic adsorption unsolved, and, as a result, makes it much more difficult to produce a large amount of composite particles while maintaining accuracy of the adsorbed amount of each of the individual composite particles to be produced.

The present invention has been made in view of the aforementioned matters. It is an object of the present invention to provide a composite particle manufacturing device constructed by a flow path having a relatively great width, being capable of controlling an adsorption ratio of particles and having a good productivity. It is also an object of the present invention to provide a method for manufacturing composite particles using the aforementioned manufacturing device.

### Solution to Problem

Therefore, in order to attain the aforementioned objects, first, a first aspect of the invention is a device for manufacturing composite particles by mixing a first fluid containing particles having positive surface potential and a second fluid containing particles having negative surface potential and causing the two kinds of particles to electrostatically adsorb each other, wherein the device comprises at least one first inlet flow path for supplying the first fluid; at least one second inlet flow path for supplying the second fluid; and a mixing flow path for merging the first fluid and the second fluid supplied respectively from the first inlet flow path and the second inlet flow path and allowing the two kinds of fluids to flow down for a predetermined length while mixing the two kinds of fluids; and the mixing flow path is a continuous flow path and has, in at least part of the entire mixing flow path, a velocity changing region for generating an eddy flow by making a change in velocity.

The two kinds of particles to be electrostatically adsorbed mentioned herein are divided by positively surface charged particles and negatively surface charged particles. Examples of the two kinds of particles include not only particles comprising a single substance but also a mixture of particles comprising a plurality of substances. Besides, either or both of the two kinds of particles can be composite particles and the composite particles can be particles in which a plurality of substances are mixed. Furthermore, the two kinds of particles can be formed of substances having different physical properties, respectively, or formed of the same substance having the same physical properties but different in shape, particle diameter, or the like. Substance, shape and particle diameter of these particles are determined in accordance with composite particles to be manufactured. In addition, “particles” include not only granular matters but also fibrous matters. The “particles” only need to be “solids” adsorbable by electrostatic attraction, and can take a variety of shapes such as a spherical shape, a rod shape, and a tubular shape.

The concept of a first fluid is fluid containing the abovementioned positively charged particles, and as long as fluid contains positively charged particles, the particles or the fluid can be of a single component or a plurality of components. Similarly, the concept of a second fluid is fluid containing the abovementioned negatively charged particles, and as long as fluid contains negatively charged particles, the particles or the fluid can be of a single component or a plurality of components. Therefore, two kinds of fluids in the present invention mean not two fluids formed of different substances but both a first fluid and a second fluid.

According to this aspect of the invention, mixing of two kinds of fluids flowing down in a mixing flow path is induced by causing a change in velocity during the movement through the mixing flow path (in part of the entire mixing flow path). Examples of a velocity changing region in part of the mixing flow path include a taper-structured flow path part taper-structured flow path part and an expansive-structured flow path part mentioned later, although the change in velocity can be caused by other structures. Examples of other structures include placement of an obstacle in the flow path and curving the flow path. Owing to the change in velocity in the mixing flow path, the two kinds of fluids merged (a mixed fluid) generate a turbulent flow (or a liquid flow which is not so turbulent but not a laminar flow) as a whole, that is to say, are put in a state close to stirring. This promotes mixing of the two kinds of fluids. The two kinds of fluids mentioned herein respectively and separately contain two kinds of particles to be electrostatically adsorbed, and mixing or stirring of the fluids is performed in order to increase the chances for the two kinds of particles to contact each other while being dispersed. Then, upon contact, the two kinds of particles can electrostatically adsorb each other and form composite particles. Well mixing of the two kinds of particles in the mixing flow path can produce a great number of composite particles in which one kind of particles are adsorbed by the other kind of particles at a predetermined ratio in an evenly adsorbed manner. That is to say, when one kind of particles are mother particles and the other kind of particles are child particles, composite particles in which the child particles are electrostatically adsorbed on surfaces of the mother particles at a predetermined ratio can be collectively produced. It should be noted that a change in velocity mentioned herein means a condition in which fluids flowing down almost simultaneously are caused to have a relative difference in velocity in a velocity changing region, and includes a difference in velocity generated between fluids flowing down near a wall surface of a flow path and around centerline of the flow path, a difference in velocity caused by a difference in flow path length between opposing wall surfaces of a flow path, and so on.

A second aspect of the invention concerning the device for manufacturing composite particles is a device for manufacturing composite particles by mixing a first fluid containing particles having positive surface potential and a second fluid containing particles having negative surface potential and causing the two kinds of particles to electrostatically adsorb each other, wherein the device comprises at least one first inlet flow path for supplying the first fluid; at least one second inlet flow path for supplying the second fluid; and a mixing flow path for merging the first fluid and the second fluid supplied respectively from the first inlet flow path and the second inlet flow path and allowing the two kinds of fluids to flow down for a predetermined length while mixing the two kinds of fluids; and the mixing flow path is a continuous flow path and has a heterogeneous cross-sectional area in a continuity direction thereof.

According to this aspect of the invention, the mixing flow path in which the two kinds of fluids merge have a heterogeneous cross-sectional flow path area. Therefore, a change in velocity is caused in the mixing flow path. Owing to the change in velocity in the mixing flow path, the two kinds of fluids merged (a mixed fluid) generate a turbulent flow and are put in a state close to stirring. This promotes mixing of the two kinds of fluids. Similar to the first aspect of the invention, mixing or stirring of the fluids promotes dispersion and an increase in opportunity of mutual contact of the two kinds of particles, and upon contact of the two kinds of particles, the two kinds of particles electrostatically adsorb each other. As a result, similarly to the first aspect of the present invention, a great number of composite particles can be produced in which the two kinds of particles electrostatically adsorb each other at a predetermined ratio. It should be noted that having a heterogeneous cross-sectional flow path area includes having a tapered shape in part or all of the flow path and having a part with an increasing or decreasing width somewhere in the flow path.

A third aspect of the invention concerning the device for manufacturing composite particles is characterized in that in the second aspect of the invention, the mixing flow path has at least one taper-structured flow path part having a gradually or stepwise decreasing cross-sectional flow path area in a downstream direction.

According to this aspect of the invention, when the two kinds of fluids introduced into the mixing flow path merge in the mixing flow path, the two kinds of particles are dispersed respectively and appropriately in a region having a relatively large cross-sectional flow path area. When the two kinds of merged fluids move to a region having a small cross-sectional flow path area, the distance between the two kinds of particles reduced and gradually come nearer to each other, and eventually one kind of particles contact and get electrostatically absorbed by the other kind of particles. Besides, a gradual decrease in cross-sectional flow path area generates a difference in velocity between the fluids flowing down around centerline of the flow path and near a wall surface. The difference in velocity causes a partially turbulent flow. This promotes mixing of the two kinds of fluids. Such mixing of the fluids leads to an increase the chances for the two kinds of particles to contact each other.

A fourth aspect of the invention concerning the device for manufacturing composite particles is characterized in that in the third aspect of the invention, the mixing flow path is constructed by a single taper-structured flow path part, and the taper-structured flow path part has a uniform depth and a tapered flow path width with an inclination of not less than 1.5/100.

According to this aspect of the invention, the mixing flow path has the same or a uniform depth. Therefore, sinking or rising is not induced or enforced during a movement through the flow path and the mixing flow path can have a tapered structure in which only the flow path width gradually decreases. Besides, since the tapered structure is very gently tapered, it is possible to secure a flow path length which offers necessary time for the two kinds of fluids (the two kinds of particles) to be gradually brought in vicinity of each other and for the two kinds of particles to adsorb each other. Note that when the tapered structure is relatively gently tapered, an increase in flow path length is inevitably preferred. Owing to the increase in flow path length, the two kinds of fluids are gradually mixed in a process of passing through the long mixing flow path and thus composite particles in which the two kinds of particles are electrostatically adsorbed at a suitable ratio can be fabricated.

A fifth aspect of the invention concerning the device for manufacturing composite particles is characterized in that in the second or third aspect of the invention, the mixing flow path has at least one expansive-structured flow path part having an appropriate volume, and the expansive-structured flow path part comprises a body part, and an inlet part and an outlet part formed by opening the body part, and the body part has a larger cross-sectional flow path area than either of the inlet part and the outlet part.

According to this aspect of the invention, the mixing flow path has an expansive-structured flow path part. Therefore, when a mixed fluid (the two kinds of fluids) enters the expansive-structured flow path part, velocity of the mixed fluid reduces. This is because the expansive-structured flow path part has an appropriate volume and the body part has a larger cross-sectional flow path area than either of the inlet part and the outlet part. In the body part, the mixed fluid flows from the inlet part toward the outlet part, but because velocity reduces, the entire volume of the mixed fluid which has entered from the inlet part cannot pass through the expansive-structured flow path part while keeping as they are, that is, keeping the velocity at the inlet part and generates a convection flow (an eddy flow). This brings a state close to stirring and promotes mixing of the two kinds of fluids. Accordingly, an effect of suppressing a variation in the amount of the one kind of particles adsorbed with respect to the amount of the other kind of particles is exhibited. It should be noted that an appropriate volume means a volume with a reduced velocity and allows fluid to circulate on an inside thereof, and means a volume not extremely large or small.

A sixth aspect of the invention concerning the device for manufacturing composite particles is characterized in that in the fifth aspect of the invention, the mixing flow path has a uniform depth, and the body part of the expansive-structured flow path part is increased in cross-sectional area by being expanded in a width direction thereof.

According to this aspect of the invention, the flow path depth is uniform. Therefore, a mixing condition can be controlled in a flow path width direction. Especially in the expansive-structured flow path part, the body part is expanded in a width direction, and thus separation in a depth direction caused by a difference in sedimentation rate of the particles can be suppressed in comparison with separation in a depth direction in a case in which the flow path area is increased in a vertical direction. Even when two kinds of particles having a great difference in specific gravity, for instance, are to be compounded, compounding is well executed. Besides, the fluids introduced into the body part of the expansive-structured flow path part separate into both sides of a width direction thereof and get circulated by convection and, after the convection circulation, come in vicinity of each other and flow down. This promotes mixing of the fluids. Owing to the mixing of the fluids, the two kinds of particles are well dispersed and mixed, and adsorbed by each other, as mentioned before.

A seventh aspect of the invention concerning the device for manufacturing composite particles is characterized in that in the sixth aspect of the invention, the body part of the expansive-structured flow path part has wall surfaces in an arc shape.

The phrase that the body part of the expansive-structured flow path part has wall surfaces in an arc shape means that the mixing flow path has a flow path structure in which both sides of the mixing flow path with respect to centerline of the mixing flow path are expanded in an arc shape. Preferably the wall surfaces are symmetrical about centerline of the mixing flow path. It is also preferred that the symmetrical shape of the entire expansive-structured flow path part is a roughly circular or oval shape.

According to this aspect of the invention, wall surfaces of the expansive-structured flow path part have an arc shape. Since a convection flow of the fluids in the expansive-structured flow path part is guided by the shape of side surfaces (wall surfaces) thereof, the fluids circulate upstream by convection in a manner to form an arc. Additionally, a region in which the fluids stagnate or do not flow can be reduced. Furthermore, when the two kinds of fluids to be mixed flow down in a laminar structure with a boundary around centerline of the mixing flow path, the two kinds of fluids are similarly circulated by convention, which brings a mixed state after the circulation to uniformity. Note that even in this aspect of the invention, owing to the mixing of the fluids, the two kinds of particles are well dispersed and adsorbed by each other.

An eighth aspect of the invention concerning the device for manufacturing composite particles is characterized in that in the fifth to seventh aspects of the invention, one mixing region unit comprises at least one each of the taper-structured flow path part and the expansive-structured flow path part, and the mixing flow path has at least one mixing region unit.

According to this aspect of the invention, the taper-structured flow path part plays a role of physically bringing the two kinds of particles in vicinity of each other and the expansive-structured flow path part plays a role of promoting mixing by stirring the fluids. Therefore, the two kinds of particles are well dispersed and mixed for electrostatic adsorption, and accordingly, a ratio of one kind of particles adsorbed with respect to the other kind of particles (an adsorption rate) is suppressed from varying. Especially when a plurality of mixing region units are provided, mixing of the particles is repeated and this repetition contributes to uniformity of the adsorption ratio.

A ninth aspect of the invention concerning the device for manufacturing composite particles is characterized in that in the eighth aspect of the invention, the mixing flow path has a standard flow path structure part having a predetermined flow path width, and the mixing region unit is provided in continuity with the standard flow path structure part.

The standard flow path structure part mentioned herein means a flow path having a standard flow path width which determines velocity in the entire mixing flow path. Upon placed upstream or downstream of the mixing region unit, the standard flow path structure part standardizes velocity of the fluids which flow down in the entire flow path.

According to this aspect of the present invention, the two kinds of fluids (the mixed fluid) to flow down in the standard flow path structure part pass through the standard flow path structure part at standard velocity, and on the other hand change their velocity in the taper-structured flow path part and the expansive-structured flow path part. Thus slowing down and normalization of velocity can be remarkably effected on the two kinds of fluids.

A tenth aspect of the invention concerning the device for manufacturing composite particles is characterized in that in the aforementioned ninth aspect of the invention, the standard flow path structure part has a flow path width decreasing gradually or stepwise in a downstream direction from the predetermined flow path width.

According to this aspect of the invention, physical distance between the particles is reduced even in the standard flow path structure part, and therefore, mixing of the fluids can be promoted even in a region other than the mixing region unit.

An eleventh aspect of the invention concerning the device for manufacturing composite particles is characterized in that in the second to tenth aspects of the invention, each of the flow paths has a depth of not less than 1 mm and a flow path width of not less than 0.5 mm.

According to this aspect of the invention, the entire flow paths can be constructed by flow paths in sizes on the order of millimeters. Therefore, unlike a microsized flow path structure, the particles or composite particles contained in the fluids are suppressed from remaining in and clogging the flow paths. Besides, the expansive-structured flow path part can secure a region large enough for sufficient circulation by convection and the taper-structured flow path part can be easily designed, so it is very easy to cause the fluids flowing down to increase or normalize their velocity. Note that in determining depth and width of the flow paths, preferably the depth and the width are three times or more of an average particle diameter of the particles to flow down or composite particles to be produced. This is because clogging can be remarkably decreased by forming the flow paths in sizes three times or greater than the average particle diameter.

A twelfth aspect of the invention concerning the device for manufacturing composite particles is characterized in that in the eleventh aspect of the invention, the velocity changing region comprises a curved part formed by partially curving the mixing flow path. The curved part has a rise and fall part formed by curvedly raising and lowering part of an inner wall surface of the mixing flow path and the rise and fall part makes a difference in flow path length between inner wall surfaces.

According to this aspect of the invention, inner wall surfaces of the mixing flow path have different flow path lengths at a curved part. Velocity of the fluids near a wall surface having a great flow path length increases when compared with that of the fluids near a wall surface having a small flow path length. As a result, when the fluids pass through the curved part, a change (a difference) in velocity is generated. Such a change in velocity induces mixing of the fluids.

A thirteenth aspect of the invention concerning the device for manufacturing composite particles is characterized in that in the twelfth aspect of the invention, the velocity changing region is repeatedly provided with the curved part in at least two locations.

According to this aspect of the invention, a change in velocity can be repeatedly caused to the fluids moving in the mixing flow path. Therefore, in association with changes in velocity, the two kinds of fluids can be sufficiently mixed. When the curved part is provided repeatedly, a curve direction of the curved part can be appropriately reversed. Then, a short flow path side and a long flow path side of the inner wall surfaces can be reversed and thus suitable mixing of the fluids can be expected.

A first aspect of the invention concerning a method for manufacturing composite particles is a method using any one of the first to eleventh aspects of the invention concerning the manufacturing device, wherein the first and second fluids are supplied respectively to the first inlet flow path and the second inlet flow path at predetermined flow rates, and a ratio of one of the two kinds of particles adsorbed with respect to the other kind of particles is controlled by a ratio of the flow rates.

According to this aspect of the invention, the two kinds of fluids to be mixed respectively and separately contain two kinds of particles at predetermined concentrations, and a ratio of the two kinds of particles to be supplied to the mixing flow path of the aforementioned manufacturing device is determined by determining flow rates of the two kinds of fluids beforehand. Then, a ratio of one kind of particles adsorbed with respect to the other kind of particles (an adsorption ratio) can be varied in proportion to this ratio of the two kinds of particles to be supplied. At this time, as described in the invention concerning the manufacturing device, the two kinds of fluids are approximately uniformly mixed in the manufacturing device. Therefore, the two kinds of particles contained in the two kinds of fluids are also mixed approximately uniformly, and accordingly, the one kind of particles can be adsorbed by the other kind of particles while being appropriately dispersed. In composite particles fabricated in such a state, the ratio of the one kind of particles adsorbed to the other kind of particles is stable at an average level over the entire produced composite particles. So, composite particles having a desired adsorption ratio can be produced in a large amount.

A second aspect of the invention concerning the method for manufacturing composite particles is characterized in that in the first aspect of the invention, a relative ratio of a flow rate of the first fluid to be supplied to the first inlet flow path to a flow rate of the second fluid to be supplied to the second inlet flow path is controlled by a flow rate control step.

According to this aspect of the invention, a relative ratio of flow rates of the two kinds of fluids is controlled by the flow rate control step, and then the two kinds of fluids are supplied to the manufacturing device and mixed. Accordingly, a relative supply ratio of the first kind of particles contained in the first fluid and the second kind of particles contained in the second fluid is controlled. Since composite particles having an adsorption ratio in proportion to the ratio of the two kinds of particles supplied can be produced as mentioned before, an adsorption ratio in composite particles can be controlled by the flow rate control step prior to supply of the fluids. Note that the flow rate control step can be performed, for example, by a relative difference between discharge pressures in supplying the fluids into the first and second inlet flow paths. In a case of gravity flow, the flow rates can be controlled, for example, by installing valves just before the inlet flow paths and adjusting opening of the valves.

A third aspect of the invention concerning the method for manufacturing composite particles is characterized in that in the first or second aspect of the invention, surface charges of the two kinds of particles contained respectively in the first fluid and the second fluid are controlled beforehand by an electric charge control step.

According to this aspect of the invention, one kind of particles (a first kind of particles) to be electrostatically adsorbed can be positively charged while the other kind of particles (a second kind of particles) can be negatively charged by an electric charge control step. Therefore, composite particles having freely selected particle characteristics (physical properties) can be produced. Besides, since the two kinds of particles are electrically charged to clearly opposite polarities beforehand, composite particles can be manufactured easily by supplying the two kinds of particles to the mixing flow path of the manufacturing device. Additionally, since composite particles having an adsorption ratio in proportion to the controlled flow rates can be produced, composite particles capable of exhibiting desired characteristics can be produced. When the two kinds of particles originally have predetermined surface charges, it is needless to say that the electric charge control step is unnecessary.

### Advantageous Effects of Invention

According to the device for manufacturing composite particles of the present invention, the device is constructed by the flow paths having relatively great flow path widths, so clogging is suppressed. Since the fluids are appropriately dispersed and mixed in the mixing flow path, individuals of the two kinds of particles respectively contained in the two kinds of fluids are brought in vicinity of each other while dispersed, and adsorbed by each other approximately uniformly as a whole, thereby producing stable composite particles. Thus, the production device improves in productivity of composite particles. Besides, the adsorption ratio of the particles can be controlled by changing flow rates of the fluids to be supplied.

Furthermore, according to the method for manufacturing composite particles of the present invention, the aforementioned device for manufacturing composite particles is used. Therefore, desired composite particles can be manufactured in a large amount by supplying the manufacturing device with the two kinds of fluids whose flow rates are controlled beforehand.

### BRIEF DESCRIPTION OF DRAWINGS

FIG. 1 is an explanatory drawing schematically showing one of a first group of embodiments of the invention concerning a device for manufacturing composite particles.

FIG. 2 are explanatory drawings showing flow path structures of the first group of embodiments according to the invention concerning the device for manufacturing composite particles.

FIG. 3 is a model state transition diagram showing fabrication of composite particles in one of the first group of embodiments concerning the device for manufacturing composite particles.

FIG. 4 are explanatory drawings showing flow path structures of a second group of embodiments of the invention concerning the device for manufacturing composite particles.

FIG. 5 are explanatory drawings showing flow path widths in the second group of embodiments of the invention concerning the device for manufacturing composite particles.

FIG. 6 are explanatory drawings showing variations of the embodiments concerning the device for manufacturing composite particles.

FIG. 7 is an explanatory drawing showing another variation of the embodiments concerning the device for manufacturing composite particles.

FIG. 8 are explanatory drawings showing shapes of inlet flow paths of embodiments concerning the device for manufacturing composite particles.

FIG. 9 are explanatory drawings showing variations of a flow path structure of the device for manufacturing composite particles.

FIG. 10 are explanatory drawings showing variations of the flow path structure of the device for manufacturing composite particles.

FIG. 11(a) is an explanatory chart showing an embodiment of the invention concerning a method for manufacturing composite particles, and FIG. 11(b) is an explanatory chart showing an embodiment of an electric surface charge control step.

FIG. 12 is an explanatory drawing showing a device for manufacturing composite particles produced for an experiment.

FIG. 13 is an explanatory drawing of a flow path structure of a device for manufacturing composite particles used in Experiment 1.

FIG. 14 is an explanatory drawing of a flow path structure of a device for manufacturing composite particles used in Comparative Example.

FIG. 15(a) is an SEM image showing a result of Experiment 1, and FIG. 15(b) is an SEM image showing a result of Comparative Example.

FIG. 16 is an explanatory drawing of a flow path structure of a device for manufacturing composite particles used in Experiment 2.

### DESCRIPTION OF EMBODIMENTS

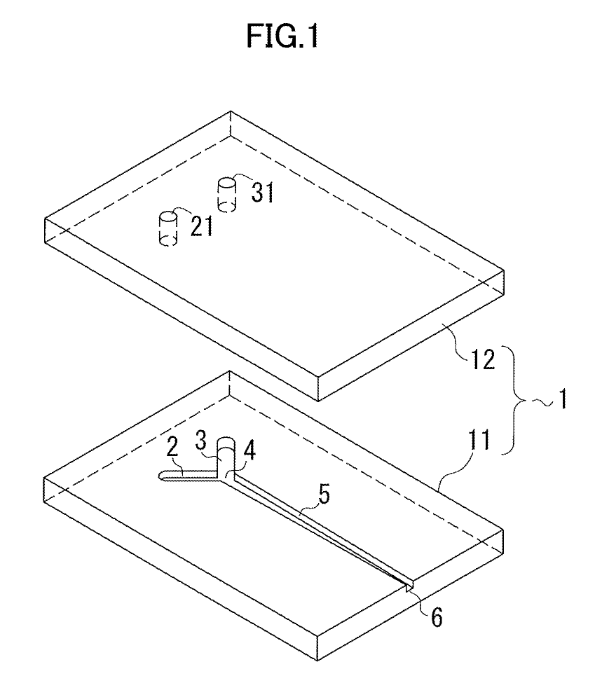

Hereinafter, embodiments of the present invention will be described with reference to the drawings. FIG. 1 is a drawing schematically showing one of a first group of embodiments of the present invention concerning the device for manufacturing composite particles. A manufacturing device 1 of this embodiment includes a flow path substrate 11 simply having predetermined flow paths in a groove shape, and a cover part 12 overlaid on the flow path substrate 11. Flow paths 2 to 5 having desired shapes as mentioned later are formed in the flow path substrate 11, and can take hollow tubular shapes by closing their groove-shaped surface openings with the cover part 12. Note that the manufacturing device 1 can also be formed in a three-layered structure by preparing a thin plate member to serve as the flow path substrate 11, forming through holes to serve as flow paths in the thin plate member, laying the thin plate member on a plate base part, and overlaying the cover part 12 on the thin plate member. In either case, owing to a uniform flow path depth, cross-sectional flow path area can be determined by flow path width.

The flow paths in this embodiment include at least two inlet flow paths 2, 3, a merging part 4 at which the at least two inlet flow paths 2, 3 merge, and a mixing flow path 5. For fluid supply to the inlet flow paths 2, 3, the cover part 12 has through holes to serve as supply parts 21, 31. The supply parts 21, 31 allow fluids (containing particles) to be supplied from an outside of the cover part 12 to the inlet flow paths 2, 3. The mixing flow path 5 is formed to reach an edge of the flow path substrate 11, and an end of the mixing flow path 5 opens at the edge of the flow path substrate 11 and forms an outlet port 6.

In the device 1 for manufacturing composite particles of the present embodiment having the abovementioned structure, upon supplied respectively to the inlet flow paths 2, 3 through the two supply parts 21, 31, two kinds of fluids respectively containing two kinds of particles merge at the merging part 4, flow down in the mixing flow part 5, and flow out from the outlet port 6. When the fluids are supplied from the supply parts 21, 31, appropriate pressure can be applied to the fluids so that the discharge pressure forces the fluids to flow down. The fluids can be passed through the flow paths also by arranging the outlet port 6 to face down and allowing the fluids to flow down naturally. The fluids can also be passed through the flow paths while rising from below by arranging the outlet port 6 to face up and applying supply pressure. The mixing flow path 5 has a special shape and structure as mentioned later and serve to control a mixed state of the two kinds of fluids and cause two kinds of particles respectively contained in two kinds of fluids to electrostatically adsorb each other, thereby manufacturing composite particles.

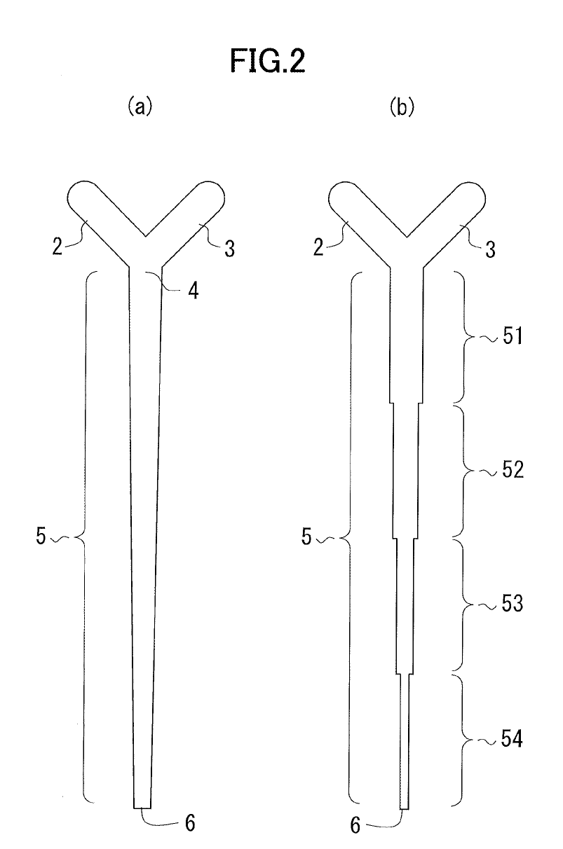

By the way, as shown in FIG. 2, flow paths of the first group of embodiments are provided by continuously arranging the branched two inlet flow paths 2, 3 and the mixing flow path 5 extending in a downstream direction from a merging point of these inlet flow paths 2, 3 (a merging part 4). FIGS. 2(a) and 2(b) show typical flow path shapes of the first group of embodiments. As shown in these figures, downstream directions of the inlet flow paths 2, 3 of each of the first group of embodiments are inclined, and both the inlet flow paths 2, 3 form an angle with each other. Ends of the inlet flow paths 2, 3 communicate with each other and form the merging part 4, and the mixing flow path 5 is provided so as to communicate with the merging part 4. The inlet flow paths 2, 3 and the mixing flow path 5 form a roughly Y-shaped flow path in order to facilitate flowing down of the fluids supplied to the flow paths.

The mixing flow path 5 is a continuous flow path having a heterogeneous cross-sectional flow path area. In the first group of embodiments, the mixing flow path 5 has a tapered shape having a gradually decreasing flow path width as a whole as shown in FIG. 2(a), or a stepwise and roughly tapered shape having a stepwise decreasing path width as shown in FIG. 2(b) (hereinafter, these shapes are sometimes collectively referred to as “tapered”).

In the first group of embodiments, the tapered mixing flow path 5 has a rectangular flow path cross section, but instead can have a circular, oval or other-shaped flow path cross section. The mixing flow path 5 has a tapered structure in which both side walls facing each other are symmetrically inclined, but the structure of the mixing flow path 5 is not limited to this as long as it is a tapered structure having a heterogeneous cross-sectional flow path area, and, for example, can be a structure in which only one side surface is inclined, or a structure in which four side surfaces are isotropically inclined.

An inclination of this tapered flow path is set to be not less than 1.5/100 over the whole of the flow path width. When flow path width at the merging part 4 is 2 mm, for instance, a flow path length of about 100 mm is necessary in order to have a flow path width of 0.5 mm at an end (the outlet port 6). A great length and a gently tapered structure of the mixing flow path 5 gradually change velocity of the fluids flowing down in the mixing flow path 5 and promote mixing of the fluids. In this meaning, the flow path having the tapered structure is one form of a velocity changing region. Since the flow paths of the first group of embodiments have a uniform depth, an inclination of the flow path width is identical with that of the cross-sectional flow path area. That is to say, fundamentally speaking, a change in velocity is caused by reducing a cross-sectional flow path area. Upon providing a uniform flow path depth, a flow path design can be realized by changing only an inclination of the flow path width. In the flow paths having the aforementioned example flow path width, upon providing a depth of 2 mm, the cross-sectional flow path area can be decreased from 4 mm² to 1 mm². As a matter of course, when the depth is 1 mm, the cross-sectional flow path area is one half of the abovementioned area.

When the both side wall surfaces of the mixing flow path 5 have a symmetrical inclination, an inclination of each of the side wall surfaces is one half of the abovementioned 1.5/100. When the inclination is gentler than 1.5/100, a difference in velocity in the mixing flow path 5 is small and the mixing flow path 5 becomes close to a parallel flow path (a straight pipe) and hardly exhibits a mixing effect. On the other hand, when the inclination is extremely steep (e.g., 1/10), the mixing flow path 5 cannot secure a sufficient flow path length. Since a flow path width of the outlet port is determined based on particle diameters of composite particles, a limit value of the flow path width is geometrically determined. Therefore, the taper of the mixing flow path 5 preferably falls within the range of 0.25/100 to 5.0/100 and more preferably within the range of 1.5/100 to 3.0/100. When a plurality of steep mixing flow paths are connected, the taper of the mixing flow paths as the whole (on average) preferably falls within the above inclination range.

In view of the above, in a case of such a straight tapered structure as shown in FIG. 2(a), a desired inclination can be obtained by inclining the both side wall surfaces in the range from the merging part 4 to the end 6. On the other hand, in a case of such a stepwise structure as shown in FIG. 2(b), a tapered shape having a desired inclination as a whole (in total) can be obtained by connecting a parallel flow path 51 having a great flow path width, parallel flow paths 52, 53 having gradually smaller flow path widths and a final parallel flow path 54 having a desired flow path width. In this meaning, it can be understood that a velocity changing region is constructed by the entire mixing flow path 5. However, these parallel flow paths 51 to 54 have gradually smaller flow path widths, and it can also be understood that the parallel flow paths on the next order serve as velocity changing regions, respectively.

Note that these parallel flow paths 51 to 54 can have tapered shapes. In this case, the flow paths 51 to 54 having tapered shapes are referred to as “taper-structured flow path parts” and distinguished from flow path structure parts having other shapes mentioned later. The single mixing flow path 5 in a straight tapered shape (see FIG. 1(a)) is one form of a single taper-structured flow path part.

The first group of embodiments having the abovementioned structures including the inlet flow paths 2, 3 capable of supplying two kinds of fluids, and the mixing flow path 5 which merges the two kinds of fluids and has a decreasing cross-sectional flow path area, aims to cause the two kinds of particles respectively contained the two kinds of fluids to electrostatically adsorb each other in the mixing flow path 5. Now, an outline of electrostatic absorption states of the particles will be described.

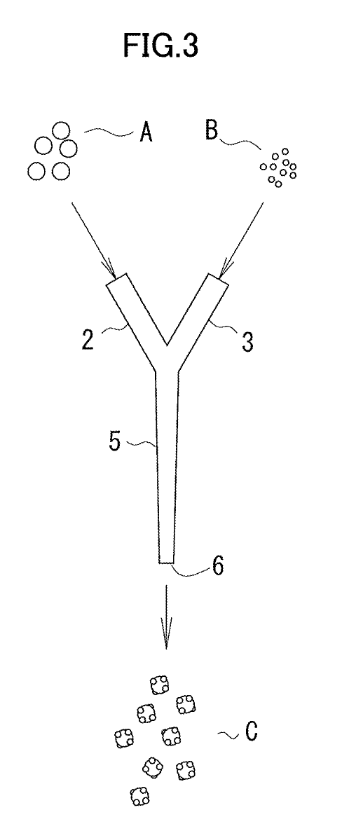

FIG. 3 is a model diagram showing particle states in use of one of the first group of embodiments. For convenience of explanation, scales of constituent elements in the drawings are not precise. As shown in this figure, a fluid to be supplied from the first inlet flow path 2 contains a first kind of particles A, and a fluid to be supplied from the second inlet flow path 3 contains a second kind of particles B. The two kinds of particles A, B contained in the respective fluids are supposed to be the first kind of particles A to serve as mother particles and the second kind of particles B to be adsorbed on surfaces of the first kind of particles A and serve as child particles. For this adsorption, it is supposed, for example, that surfaces of the first kind of particles A are positively charged, and surfaces of the second kind of particles B are negatively charged so as to oppose polarity of the surfaces of the first kind of particles A. Upon electrically charged to opposite polarities to each other, the two kinds of particles A, Bare electrically adsorbed by each other in being mixed in the mixing fluid path 5. In the abovementioned example, composite particles C are formed in which the second kind of particles B are adsorbed on surfaces of the first kind of particles A.

The two kinds of fluids respectively and separately containing these particles A, B are separately supplied from the inlet flow paths 2, 3 and mixed in the mixing flow path 5. Thus, individuals of the two kinds of particles A, B are brought in vicinity of each other and allowed to electrically adsorb each other. Therefore, the mixing flow path 5 is provided as a structure for simply mixing the two kinds of fluids. Although only a mixed state of the fluids will be hereinafter described in some cases, appropriate mixing of the fluids means that the two kinds of particles A, B can be brought inappropriate vicinity of each other.

Individuals of the two kinds of particles A, B to be electrostatically adsorbed by each other can be of a single substance, or individuals of either one or both kinds of particles can be composite particles. In this case, each kind of particles A, B can be of a single substance or a mixture of a plurality of substances. Especially when a charge control agent for positive or negative surface charge is adsorbed on the particles A, B, as a matter of course, the particles A, B are not of a single substance. Besides, although in some cases two kinds of particles A, B are divided by different physical properties (are of different substances), in some other cases particles are of the same substance and divided by a change in surface potential, and in some cases these are divided by shape, particle diameter, etc. and regarded as different kinds. Furthermore, in some cases, particles are divided into two kinds by regarding particles having a plurality of different physical properties and controlled to have positive surface potential as one group, and particles having a plurality of different physical properties and controlled to have negative surface potential as the other group. In short, particles are divided into two groups by positive and negative surface charges regardless of substance. Choice of these particles A, B is appropriately changed in accordance with composite particles to be fabricated. In addition, “particles” include not only granular matters but also fibrous matters or the like. The “particles” only need to be “solids” capable of being adsorbed by electrostatic attraction, and can take a variety of shapes such as a spherical shape, a cigar shape, and a tubular shape.

Particles which are different in a variety of physical properties or chemical composition can be appropriately selected as the particles A, B. In some cases, one kind of particles are metal particles, and the other kind of particles are ceramic particles, but the particles A, B are not limited to these, and different kinds of metallic particles can form composite particles, and an alloy, cermet, glass, a carbon material, or a resin material can be used as one kind of particles.

Examples of metal particles include aluminum, nickel, iron, titanium, gold, silver, platinum, and copper. Examples of ceramic include a variety of metal oxides, metal nitrides, and metal carbides, although ceramic is not limited to these. Note that metal oxide can be either simple oxide or composite oxide. Examples of ceramic include alumina, zirconia, silicon nitride, silicon carbide, magnesia, calcia, titania, vanadium oxide, spinel, and ferrite.

Examples of resin materials to be appropriately used include general-purpose thermoplastic resin such as acrylic resin including methacrylic resin, styrene resin, vinyl resin, amide resin, and cellulose resin, thermoplastic resin such as epoxy resin and phenol resin, and a variety of engineering plastics such as polyimide resin, polycarbonate resin and fluorine-containing resin.

Either one or both kinds of particles can be nanosized particles (what are called nanoparticles). This enables fabrication of nanosized composite particles.

The particles A, B exemplified above are supplied from the inlet flow paths 2, 3, while separately contained in the fluids. Preferably, fluids to contain these particles A, B do not have an extremely high viscosity. This is because when fluids have an extremely high viscosity, velocity excessively decreases near wall surfaces of the mixing flow path 5 and desired velocity cannot be obtained.

Fluid viscosity only needs to fall in a range in which a state as ordinary liquid is maintained. The viscosity is, for example, not less than 0.5 Pa·s, and preferably within the range of 0.5 mPa·s to 1.3 mPa·s. Therefore, for example, water, ethanol, methanol and mixtures thereof can be used. As for temperature in using these fluids, these fluids have viscosities in the abovementioned range at normal temperature. For reference, viscosity of pure water, ethanol, methanol, and mixtures thereof at various temperatures are shown in Table 1. As shown in this table, these fluids have viscosities in the abovementioned range at all of 15 deg. C., 25 deg. C., and 35 deg. C. Note that when fluids contain the particles A, B, viscosity of the entire fluids can be changed, but this change is a change in apparent viscosity and give little effect on an actual flowing down condition.

TABLE 1

| | | METH- | VISCOSITY | | |
|---|---|---|---|---|---|
| WATER | ETHANOL | ANOL | 15 deg. C. | 25 deg. C. | 35 deg. C. |
| 100% | | | 1.14 | 0.894 | 0.723 |
| | 100% | | 1.332 | 1.096 | 0.914 |
| | | 100% | 0.617 | 0.533 | 0.465 |
| 75% | 25% | | 1.188 | 0.9445 | 0.77075 |
| 75% | | 25% | 1.00925 | 0.80375 | 0.6585 |
| 50% | 50% | | 1.236 | 0.995 | 0.8185 |
| 50% | | 50% | 0.8785 | 0.7135 | 0.594 |

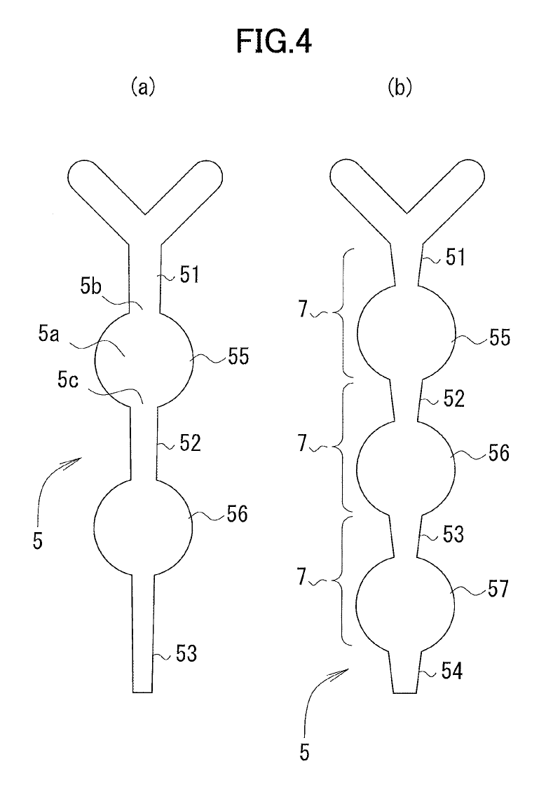

Next, a second group of embodiments concerning the device for manufacturing composite particles will be described. Since devices of the second group of embodiments are similar to those of the first group of embodiments except flow path structures, only the flow path structures will be described hereinafter. FIG. 4 illustrate two kinds of flow path structures of the second group of embodiments. In the embodiments illustrated in the drawings, a mixing path flow 5 has expansive-structured flow path parts 55 to 57 each having an appropriate volume. The expansive-structured flow path parts 55 to 57 are provided as velocity changing regions.

The expansive-structured flow path parts 55 to 57 serve to promote mixing in the mixing flow path, and are expanded on both sides (in width directions thereof) with respect to a downstream direction of fluids (a longitudinal direction of the flow path). Each of the expansive-structured flow path parts 55 to 57 includes a body part 5a, an inlet part 5b which is an opening of the body part 5a and allows the fluids to flow in, and an outlet part 5c which is an opening of the body part 5a and allows the fluids to flow out. With an increase in width of the body part 5a, each of the expansive-structured flow path parts as a whole can have a predetermined volume. The increase in width of the body part 5a means that the body part 5a has a greater flow path width than either of the inlet part 5b and the outlet part 5c. Both right and left side surfaces are symmetrically expanded, and an increase in flow path width of the expanded part slows down velocity of the introduced fluids and induces an eddy flow or convection to be generated. Owing to the generation of convention or an eddy flow, a state close to stirring is caused in each of the expansive-structured flow path parts 55 to 57, thereby suitably promoting mixing of the fluids. The predetermined volume of each of the expansive-structured flow path parts 55 to 57 means a volume large enough to sufficiently slow down velocity of introduced fluids and allow convection of the fluids while enabling the fluids to flow down (travel) downstream as a whole. For example, the predetermined volume capable of exhibiting a sufficient mixing effect can be obtained by designing the body part 5a so as to have a flow path width and a flow path length which are three times to ten times of the flow path width of the inlet part 5b.

By the way, when the inlet flow part 5b and the outlet flow part 5c are located, for example, on centerline of the body part 5a as shown in the drawings, there is a great difference between velocity of fluid flowing near centerline of the flow path and velocity of fluid flowing near wall surfaces of the flow path. The difference in velocity causes an eddy flow and fluid convection in the body part 5a of the expansive-structured flow path part. This gives a stirring effect and promotes mixing of the fluids. In such a case as shown in the drawings, an eddy flow occurs on each side of the centerline. Owing to such mixing of the two kinds of fluids, the two kinds of particles respectively contained in the two kinds of fluids are brought in vicinity of each other while respectively dispersed. This increases opportunity of extensive contact of one kind of particles with the other kind of particles.

The second group of embodiments have a plurality of expansive-structured flow path parts 55 to 57. An embodiment shown in FIG. 4(a) has two expansive-structured flow path parts 55, 56, and an embodiment shown in FIG. 4(b) has three expansive-structured flow path parts 55, 56, 57. Flow paths 51 to 54 excluding the flow paths 55 to 57 are all taper-structured flow path parts having tapered shapes. In the embodiment shown in FIG. 4(a), the tapered shapes have a gradually decreasing widths from the upstream flow path 51 toward the downstream flow path 53. In the embodiment shown in FIG. 4(b), a structure part having the same inclination is repeatedly provided.

That is to say, in the embodiment shown in FIG. 4(a), the taper-structured flow path parts 51 to 53 continuously decrease in width and the expansive-structured flow path parts 55, 56 intrude between the taper-structured flow path parts 51, 52, and 52, 53, respectively. On the other hand, in the embodiment shown in FIG. 4(b), one mixing region unit 7 is constructed by one taper-structured flow path part 51 and one expansive-structured flow path part 55, and repeated, so three mixing region units 7 are connected in series.

In either of the embodiments described above, there is a difference in velocity between fluids flowing down inside the taper-structured flow path parts 51 to 54 and fluids flowing inside the expansive-structured flow path parts 55 to 57. Especially velocity of fluids flowing down from an upstream of the expansive-structured flow path parts 55 to 57 is slowed down by the expansive-structured flow path parts 55 to 57, and this velocity slowing down generates convection (an eddy flow). This velocity slowing down increases the difference in velocity between fluids flowing on the inside and this difference in velocity causes swirl inside the expansive-structured flow path parts 55 to 57 and as a result generates convention (an eddy flow) inside the expansive-structured flow path parts 55 to 57.

By the way, in the second group of embodiments, wall surfaces of each of the expansive-structured flow path parts 55 to 57 (on both right and left sides of the body parts 5a) have an arc shape, and especially those illustrated in drawings have a circular arc shape, and convection (an eddy flow) generated by the velocity slowing down is guided in directions along the arc-shaped wall surfaces. Accordingly, for a simple object of velocity slowing down, shape of wall surfaces of the expansive-structured flow path parts 55 to 57 is not limited to an arc and, for example, can be a straight wall surface shape so as to forma rectangular part as a whole. However, an arc shape (part of a circle or an oval) is preferred in order to guide convection (an eddy flow) effectively. In such a case of straight wall surfaces to form a rectangular shape, a flow may stagnate locally in some regions, but mixing of the fluids is enabled by velocity slowing down.

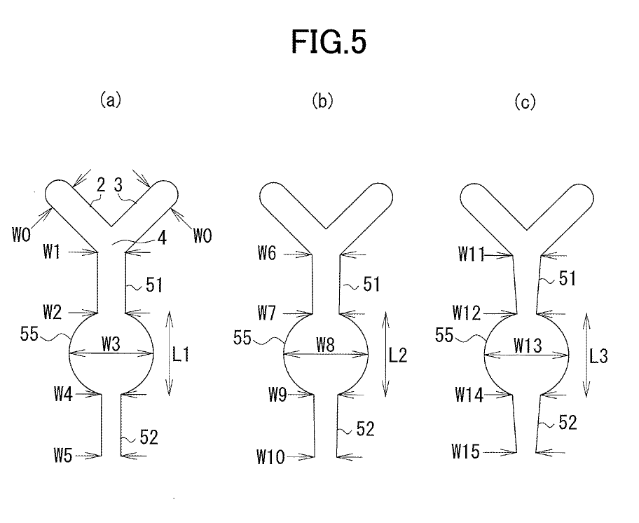

Now, flow path width of the mixing flow path 5 having the expansive-structured flow path parts 55 to 57 will be described. FIG. 5 show three forms of the mixing flow path 5 having the expansive-structured flow path part 55.

In FIG. 5(a), an upstream flow path 51 and a downstream flow path 52 of an expansive-structured flow path part 55 are parallel flow paths (straight flow paths), but flow path width of the downstream flow path 52 is smaller than that of the upstream flow path 51, and these flow paths as a whole have an inclination (a tapered shape). Therefore, in the drawing, W1=W2, W4=W5, but W3>W2>W4. In this form of the mixing flow path 5, a flow path width W4 of an outlet part is smaller than a flow path width W2 of an inlet part in the expansive-structured flow path part 55, and accordingly, a cross-sectional flow path area of the outlet part is smaller. In this case, velocity of the fluids in flowing out of the expanded flow path structure 55 is greater than that of the fluids in flowing into there. Additionally, velocity is slowed down in a body part of the expansive-structured flow path part 55. Therefore, volume of fluids circulated by convection in the body part tend to be great. Note that a ratio of the flow path widths W2 to W3 (W2:W3) is 1:3 to 1:5 in this form of the mixing flow path 5. Since the flow path depth is uniform, a ratio of cross-sectional flow path areas is the same as the above flow path width ratio. A flow path length L1 of the body part is approximately the same as W3 and wall surfaces of the body part have a circular arc shape.

In FIG. 5(b), an upstream flow path 51 and a downstream flow path 52 of an expansive-structured flow path part 55 have tapered shapes and are inclined at the same inclination as a whole (excluding the expansive-structured flow path part 55). Therefore, in the drawing, W6>W7 and W9>W10. Since a flow path width W8 of a body part is the greatest, W8>W6>W7>W9>W10 altogether. Note that a flow path length L2 and wall surface shapes are similar to those of FIG. 5(a). In this form of the mixing flow path 5, too, a ratio of the flow path widths W7 to W8 (W7:W8) is 1:3 to 1:5. In this case, too, velocity of fluids in flowing out of the expansive-structured flow path part 55 is greater than that of the fluids in flowing into there, and velocity is slowed down in the body part of the expansive-structured flow path part 55. In other words, a phenomenon of removing a difference between inlet velocity and outlet velocity (improving material balance) occurs in the body part of the expanded flow path structure 55. As a result, an eddy flow occurs, for instance.

In FIG. 5(c), both an upstream flow path 51 and a downstream flow path 52 of an expansive-structured flow path part 55 are taper-structured flow path parts having tapered structures of the same dimension. Therefore, in the drawing, W11>W12 and W14>15, but W11=W14 and W12=W15. Note that a flow path width ratio of W11 to W12 (W11:W12) and a flow path width ratio of W14 to W15 (W14:W15) are both 3:1. A flow path width W13 of a body part is greater than a greater flow path width W11 (W14) of the taper-structured flow path part. A flow path width overall ratio in this form of the mixing flow path 5 is W11 (W14):W12(W15):W13=3:1:5, and a cross-sectional flow path area ratio is similar to this flow path width ratio. Note that a flow path length L3 and wall surface shapes are the same as those of FIG. 5(a). In such a form of the mixing flow path 5, velocity of fluids flowing out from an outlet part is slower than that of fluids in flowing in from an inlet part, and velocity is highest at W12 and W15, which have a smallest width (narrow width). In such a form of the mixing flow path 5, velocity near the outlet part is relatively slow and the fluids tend to stagnate in the body part. This facilitates generation of convection (an eddy flow) in the body part.

In any of these forms of the mixing flow path 5, there is a difference in velocity between the fluids flowing into the body part and the fluids flowing out of the body part of the expansive-structured flow path part 55, and at the same time, a great difference is made between velocity near centerline of the flow path and velocity near the wall surfaces. These phenomena can cause convection (an eddy flow) inside the expansive-structured flow path part 55. Besides, since velocity is different between the fluids in flowing in and the fluids in flowing out, velocity imbalance can cause convection (partly a backward flow) or an eddy flow inside the body part of the expansive-structured flow path part 55.

Embodiments of the device for manufacturing composite particles, especially forms of flow paths are not limited to those described above, and can have other flow path shapes. Now, other variations will be described below.

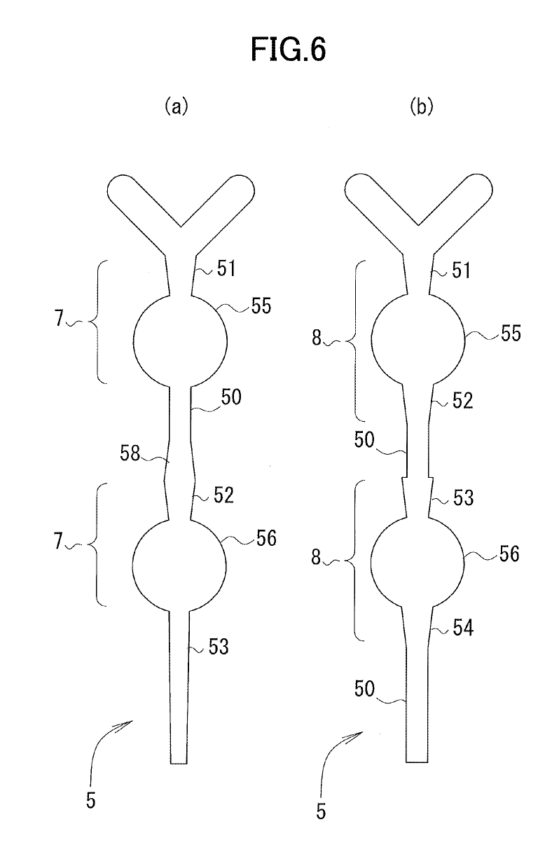

FIG. 6 show variations of one of the second group of embodiments (See FIG. 4(b)). A variation shown in FIG. 6(a) includes two mixing region units 7 such as the aforementioned one, and a standard flow path structure part 50 interposed between the two mixing region units 7. This standard flow path structure part 50 is constructed by a parallel flow path (a straight flow path), and has an average flow path width of those of flow paths except expansive-structured flow path parts 55 and 56. Fluids flowing down in the standard fluid path structure part 50 has standard velocity of the fluids flowing down through the entire flow paths. Therefore, temporary return to standard velocity distinguishes a velocity change before and after passing through the standard fluid path structure part 50, and this velocity change promotes mixing of the fluids.

A variation shown in FIG. 6(b) also includes a standard flow path 50. In this variation, one mixing region unit 8 comprises an expansive-structured flow path part 55 or 56, its upstream flow path 51 or 53 and its downstream flow path 52 or 54. The upstream flow paths 51, 53 and the downstream flow paths 52, 54 are taper-structured flow path parts all having the same shape, and are a variation of a combination of flow paths which construct one mixing region unit. The standard flow path part 50 gives similar effects to those mentioned above.

Note that flow path width (cross-sectional flow path area) of such a standard flow path structure part 50 as constructed above is determined so as to obtain desired velocity at the taper-structured flow path part or at the expansive-structured flow path part when highest velocity of the fluids flowing down in the standard flow path structure part 50 is regarded as standard velocity.

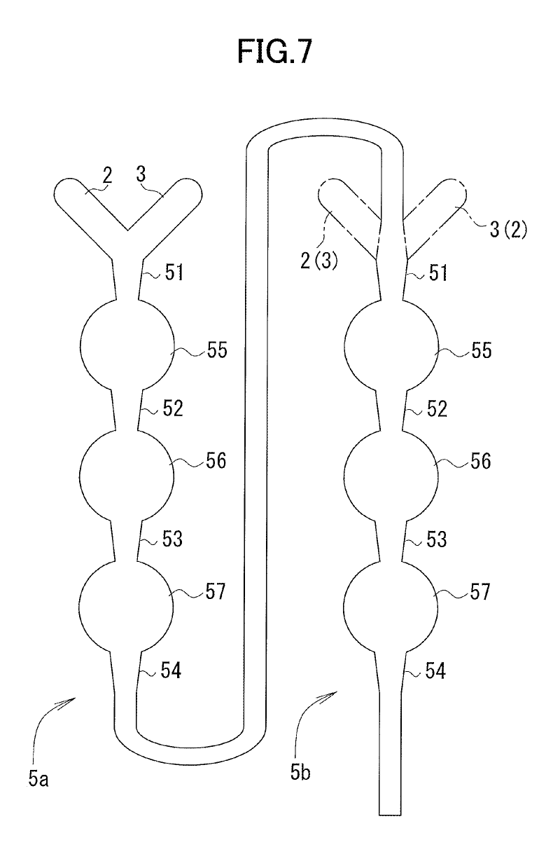

Furthermore, FIG. 7 shows another variation including a plurality of mixing flow paths 5a, 5b arranged in parallel. In this variation, a mixed fluid which has passed through a first mixing flow path 5a is caused to flow into a second mixing flow path 5b. Thus, two kinds of fluids are passed through taper-structured flow path parts 51 to 54 and expansive-structured flow path parts 55 to 57 a plurality of times. This structure aims to increase the number of times of stirring the two kinds of fluids (opportunity of contacting the two kinds of particles) by changing velocity a plurality of times. Note that the mixed flow paths 5a, 5b are arranged in parallel in order to prevent the entire flow paths from being very long. Moreover, inlet flow paths 2, 3 can be added to the second mixing flow path 5b so as to be capable to supply the two kinds of fluids, or only either one of the inlet paths 2, 3 can be added. The one or more additional inlet flow paths 2, 3 are used in order to control an adsorption ratio (a ratio of one kind of particles electrostatically absorbed with respect to the other kind of particles) in composite particles to be produced. Moreover, when two inlet flow paths 2, 3 are added, their supply positions can be reversed to those to the first mixing flow path 5a. This arrangement is made in consideration of a situation in which two kinds of fluids supplied to the first mixing flow path 5a flow down while being divided into right and left. A purpose of this arrangement is to promote mixing by bringing one kind of fluid in contact with the other kind of fluid from an outside even when the two kinds of fluids flow down as a laminar flow, and thereby fully use particles remaining near wall surfaces on both the right and left sides.

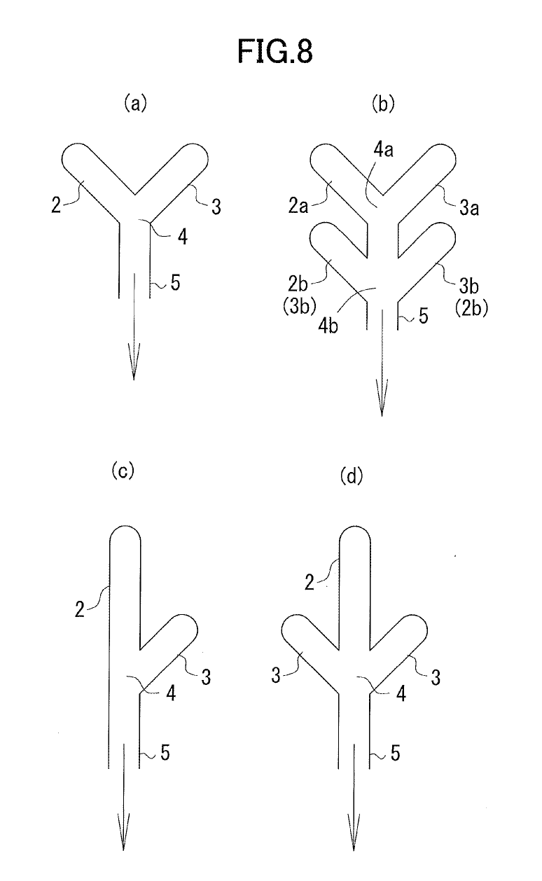

FIG. 8 show a variety of arrangements of inlet flow paths 2, 3. The inlet flow paths 2, 3 serve to supply two kinds of fluids to a mixing flow path 5, and the production device need to have at least one each of the inlet flow paths 2, 3, but a downstream direction and the number of each can be appropriately changed. FIG. 8(a) shows a typical example of the inlet flow paths 2, 3 shown in the aforementioned embodiments, and FIGS. 8(b) to 8(d) show its variations.

In FIG. 8(b), second inlet flow paths 2b, 3b having similar structures to those of first inlet flow paths 2a, 3a are disposed on a downstream side of a merging part 4a at which the first inlet flow paths 2a, 3a merge. Flow rates can be controlled by supplying desired fluids from the inlet flow paths 2a to 3b. Note that the kind of fluids to be supplied to the second inlet flow paths 2b, 3b can be reversed to those to be supplied to the first inlet flow paths 2a, 3a. Although the two kinds of fluids are eventually mixed also in this variation, an improvement in a mixed state of the two kinds of fluids can be expected by reversing the kind of fluids to be supplied from the inlet flow paths 2b, 3b. Moreover, fluids to be introduced from the inlet flow paths 2b, 3b can contain different kinds of particles from those of particles contained in the fluids to be introduced from the inlet flow paths 2a, 3a.

FIG. 8(c) shows a variation in which downstream directions of inlet flow paths 2, 3 are slightly changed. FIG. 8(d) shows a variation in which a first inlet flow path 2 supplies a first fluid straight to a mixing flow path 5 and second inlet flow paths 3 supply a second fluid from both sides obliquely to the first inlet flow path. A supply amount (a flow rate) of the second fluid can be remarkably increased when compared to that of the first fluid by placing one second inlet flow path 3 on each side (two in total).

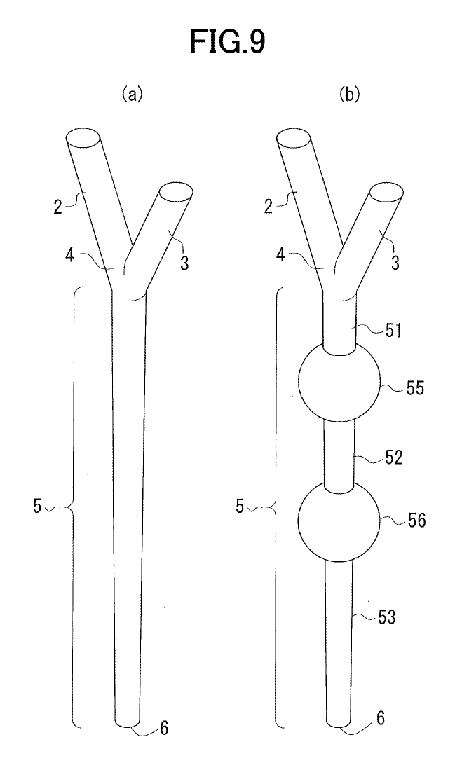

FIG. 9 show variations in which a mixing flow path 5 has a circular cross-sectional shape. The drawings three-dimensionally show only parts constructing flow paths. FIG. 9(a) shows a mixing flow path 5 simply having a tapered shape, and is a variation of FIG. 2(a). FIG. 9(b) shows a mixing flow path 5 including taper-structured flow path parts 51, 52, 53 and expansive-structured flow path parts 55, 56, and is a variation of FIG. 4(a). As shown in these drawings, a change in cross-sectional flow path area can be achieved not only by a planar (two-dimensional) change in flow path width but also by a three-dimensional change in entire flow paths. A downstream direction of the flow paths can be a plane direction (see FIG. 1) or can be a vertically downward direction. Note that inlet flow paths 2, 3 can be disposed at the bottom and fluids can be fed upward under pressure.

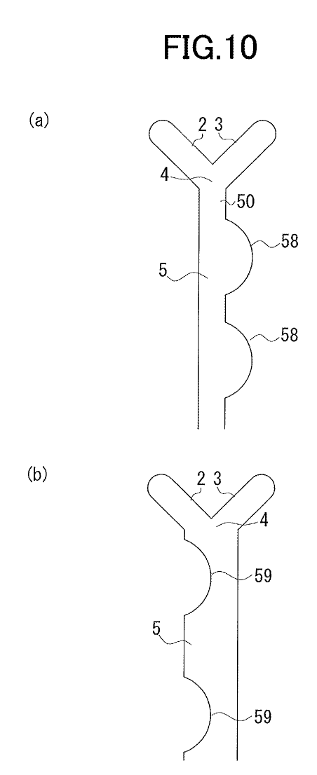

Furthermore, a mixing flow path 5 can have such structures as shown in FIGS. 10(a) and 10(b). These drawings show variations of shape of a velocity changing region. FIG. 10(a) shows a variation in which a parallel flow path (a standard flow path structure part) 50 is used as a base and flow path width is increased by forming bulging parts (a variation of expansive-structured flow path parts) 58, which are bulges of only one side surface of a flow path 5. FIG. 10(b) shows a variation in which flow path width is decreased by forming projecting parts 59, which protrude inward in a flow path 5. Upon using a parallel flow path as a base and increasing or decreasing width of part of the flow path, fluids flowing down in the mixing flow path 5 change their velocity near the bulging parts 58 or the projecting parts 59 and induce a stirring effect.

Note that the bulging parts 58 or the projecting parts 59 shown in the drawings are located in vicinity of each other, but can also be located at an appropriate distance from each other. Moreover, the bulging parts 58 or the projecting parts 59 can be provided repeatedly over the entire mixing flow path 5, but can also be provided in part of the mixing flow path 5. For example, the bulging parts 58 or the protruding parts 59 can be provided only on an upstream or downstream side and other parts of a mixing flow path 5 can be parallel flow paths or tapered flow paths. When other parts of the mixing flow path 5 are tapered flow paths, it means that different forms of velocity changing regions are provided in the same flow path. In this way, plural forms of velocity changing regions can be combined in order to obtain an effect of mixing fluids (a stirring effect).

In addition to the above structures, a velocity changing region can also be formed by curving part of a mixing flow path, although not shown. When the mixing flow path is curved, preferably flow path inner walls have smooth curves. Upon rendering concentric circular arc shapes, for instance, to flow path inner walls, a small-diameter curved part and a large-diameter curved part are provided. These curved parts have different curve lengths, and velocity of fluids flowing down along the short-curve wall surface relatively slows down when compared to that of fluids flowing down along the long-curve wall surface. Thus a change in velocity can be generated. Moreover, when flow path inner walls are not smooth (have corners), for instance, sometimes a fluid flow remarkably stagnates and part of fluids stay where they are and a mixed state at a predetermined ratio cannot be obtained. However, such stagnation can be prevented by forming smooth wall surfaces. The curve shape is generally an L or U shape, though it can be other shapes. Moreover, the number of the curved part need not be one and can be plural.

Although the embodiments of the device for manufacturing composite particles have been described above, the present invention is not limited to these embodiments. A variety of modifications are possible without departing from the gist of the present invention, and flow paths can be constructed by a combination of part or whole of the aforementioned embodiments. For example, a standard flow path structure 50 (see FIG. 6) uses a parallel flow path as a standard, but can be replaced with a tapered flow path. Such a tapered flow path can be designed using velocity at a middle position of an inclination as standard velocity.

The projecting parts 59 provided in the mixing flow path 5 protrude inward in a circular arc shape. However, as long as projecting parts can reduce a flow path width, the projecting parts are not limited to these, and can be bell-shaped projections or rectangular projections. Moreover, as long as a flow path shape can generate an eddy flow in the fluids flowing down, the flow path shape is not limited to those having a decreasing flow path width. For example, in supplying two kinds of fluids from the inlet flow paths 2, 3 velocity of one kind of fluid can be greatly increased when compared to that of the other kind of fluid. A great difference in relative velocity can generate an eddy flow. In such a case, a velocity changing region can be omitted in a flow path.

Moreover, flow rate control means, not shown, can be provided in order to give appropriate flow rates in supplying two kinds of fluids to the inlet flow paths 2, 3, respectively. This flow rate control means is a device for simply controlling discharge rates of the fluids to the inlet flow paths 2, 3, and can be constructed by a pressure device (a pump) and, if necessary, a control valve. A change in discharge rate leads to a change in supply rate. The supply rate can also be changed by controlling velocity of a pressurized fluid. This is because flow rates can be controlled by changing velocity in the same cross-sectional flow path area.

As a matter of course, fluid feed pipes are necessary as flow paths from such flow rate control means to the supply parts 21, 31 (FIG. 1), and a fluid delivery pipe connected to the outlet port 6 (FIG. 1) is also necessary in order to collect a mixed fluid containing composite particles after mixing. So, the present invention can be grasped as a manufacturing device including these pipes.

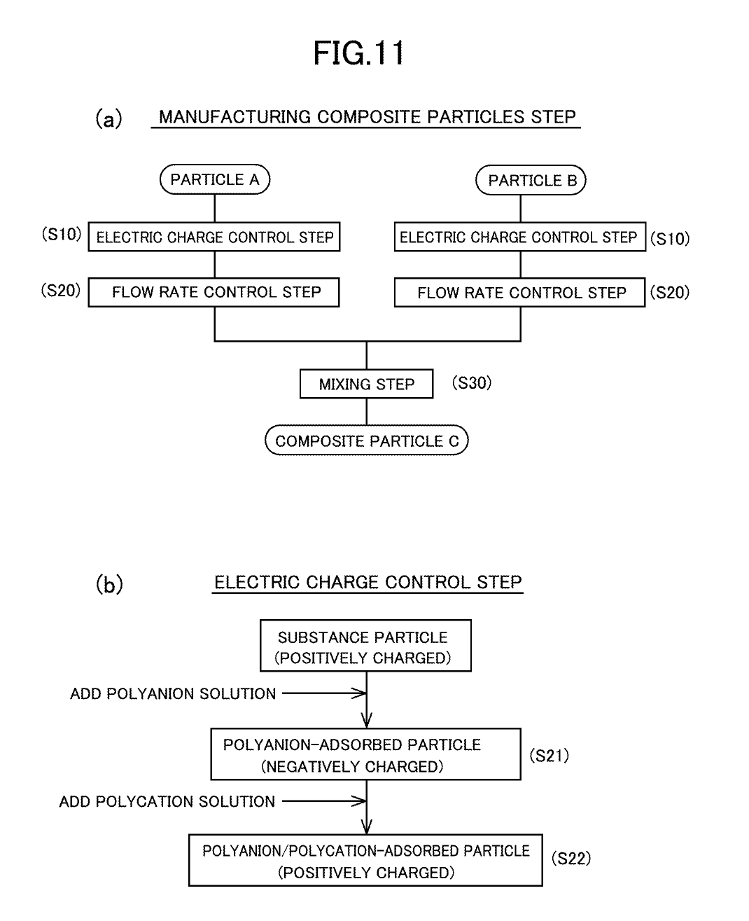

Next, a method for manufacturing composite particles using the aforementioned production device will be described. An example of the method is shown in FIG. 11(a). As shown in this drawing, surface charges of particles A, B are separately controlled by an electric charge control step (S10). The electric charge control step mentioned herein controls the particles A, B so as to have opposite polarities to each other. For example, when surface potential of the particles A is controlled to have a positive value, surface potential of the particles B is controlled to have a negative value. When the particles A or B already have predetermined surface potential, however, the electric surface charge control step for these particles can be omitted.

Since the electric charge control step for the particles A, B is performed while fluids separately contain the particles A, B, flow rates of the fluids are controlled (S20) while the fluids separately keep containing the particles A, B having controlled surface charge potential. Then the fluids are supplied to the manufacturing device and mixed (S30).

Now, surface potential control of the particles A, B will be described in detail. The surface potential control of the particles A, Buses an anionic electrolyte or a cationic electrolyte. When the particles A or B are positively charged, an anionic electrolyte is introduced to negatively charge the particles. In contrast, when the particles A or B are negatively charged, a cationic electrolyte is introduced to positively charge the particles. After that, polarity of these particles can be reversed. These particles A, B are respectively contained in separate fluids and surface charge of the particles A, B in the fluids is controlled by adding a solution of polyanions (an anionic electrolyte) or a solution of polycations (a cationic electrolyte) to the fluids, respectively.

FIG. 11(b) shows steps of performing an electric charge control step on positively charged particles. When particles contained in a fluid are positively charged as shown in FIG. 11(b), first a polyanion solution is added, thereby negatively charging surfaces of the particles (S21), and then a polycation solution is added, thereby positively charging surface potential of the particles (S22). Owing to this electric charge control step, the surfaces of the particles are positively charged almost uniformly and become ready to be electrostatically adsorbed well by negatively charged particles. In contrast to the particles shown in the drawing, when particles are negatively charged, first a polycation solution is added to a fluid containing the particles and then a polyanion solution is added, thereby negatively charging the particles.

Note that these additions of the polyanion solution and the polycation solution need not be alternately once for each of the solutions. When substance particles to be mixed are charged to the same polarity, a solution to reverse polarity of one kind of particles can be further added. Otherwise, only one of the polyanion solution and the polycation solution can be added once. The abovementioned surface electric charge control is based on the invention made by the present inventors (International Publication No. WO2012/133696) and a detailed description is omitted. Upon positively or negatively charging both the particles A and B with uniformity, the particles A, B are uniformly dispersed in the fluids, respectively.

The particles A, B thus uniformly dispersed in the two kinds of fluids, respectively, are brought in vicinity of each other by mixing of the two kinds of fluids and are electrostatically adsorbed by each other in a mixed fluid, whereby composite particles are manufactured. Therefore, upon appropriate mixing of the fluids supplied to such a manufacturing device (a flow path structure) as mentioned above, a ratio of one kind of particles adsorbed with respect to the other kind of particles (an adsorption ratio) can be controlled in accordance with volumes of the two kinds of fluids supplied (the amounts of the particles). Owing to the controllable adsorption ratio, composite particles having desired characteristics can be produced. Moreover, the number of particles which remain unused for composite particles can be extremely decreased, and uniform composite particles can be produced without greatly departing from a predetermined adsorption ratio.

Although the embodiment of the manufacturing method has been described above, the present invention is not limited to the above. A variety of modifications are possible within the spirit and scope of the present invention. For example, the flow rate control step can employ a pump, etc. in the aforementioned production device, but in a case of fluid supply by gravity, flow rates of the fluids can be controlled only by changing opening of valves. Moreover, in a manufacturing device having a plurality of inlet flow paths 2 or/and 3 as shown in FIG. 8(b) or 8(d), flow rates can be controlled by supplying or not supplying fluid to each of the inlet flow paths 2, 3. Furthermore, when the amount (concentration) of particles contained in the fluids can be controlled beforehand, the flow rate control step can be omitted.

### EXAMPLES

In regard to the devices for manufacturing composite particles described in the above embodiments, actual devices were produced and experiments for manufacturing composite particles were carried out. Examples will be described hereinafter.

### Devices Used in Experiments

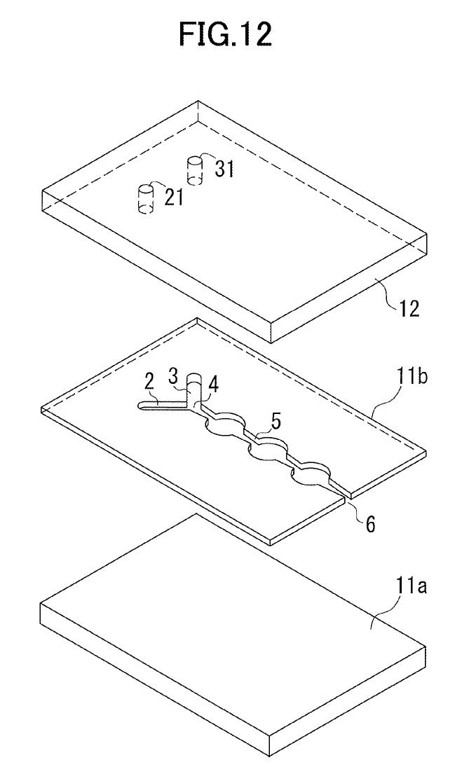

Each of the devices used in the experiments has a three-layered structure as shown in FIG. 12. A flow path substrate is constructed by a plate base part 11a comprising a flat plate-shaped member, and a flow path-forming substrate 11b comprising a thin plate-shaped member having through holes to serve as flow paths. A manufacturing device is formed by overlaying a cover part 12 on the flow path substrate. Although the drawing exemplarily shows shapes of flow paths having expansive-structured flow path parts, shapes of flow paths were changed in accordance with experiments as mentioned below. Acrylic plates were used as these members and the flow path-forming substrate 11b was produced by cutting out flow paths in desired shapes with a laser cutting machine with a laser cutter.

### Particles and Fluids for Experiments

One kind of particles used as mother particles were alumina particles having a particle diameter of 1.5 μm and produced by Sumitomo Chemical Industry Company Limited. The other kind of particles used as child particles were alumina particles having a particle diameter of 100 nm and produced by the same company. Surface potential of the child particles (a first kind of particles) was controlled to have a positive value, and surface potential of the mother particles (a second kind of particles) was controlled to have a negative value. Charge control agents (electrolytes) for control of surface potential were polystyrene sulfonate (PSS) for negative charge and poly(diallyl dimethyl ammonium chloride) (PDDA) for positive charge.

A PDDA solution and a PSS solution were prepared. The mother particles (the second kind of particles) were negatively charged by the PSS solution and then positively charged by the PDDA solution, and again negatively charged by the PSS solution. The child particles (the first kind of particles) were negatively charged by the PSS solution and then positively charged by the PDDA solution. Note that the PDDA solution was prepared by adding 1 wt. % PDDA and 0.5 mol sodium chloride to 1 liter of pure water. The PSS solution was prepared by adding 1 wt. % PSS and 0.5 mol sodium chloride to 1 liter of pure water.

Surface potential control in the experiments was as follows. After adding particles to the PDDA solution or the PSS solution, the solution containing the particles was stirred. Then, the particles were sedimented by a separating operation using a centrifugal separator and a supernatant solvent was removed. Then, a washing step comprising adding pure water, stirring a mixture, separating the particles from the pure water by the centrifugal separator and removing the pure water was repeated three times in order not to leave PDDA or PSS. Thus electric charge treatment using the PDDA or PSS solution was applied.

The first fluid and the second fluid use pure water (25 deg. C, viscosity: 0.894 mPa·s) and their volume were adjusted to 240 ml when the first fluid and the second fluid contain the two kinds of particles, respectively.

### Structure for Fluid Supply

Two dual plunger pumps produced by YMC CO., LTD. were used as a device for supplying the fluids to inlet flow paths, that is, supplying one kind of fluid to a first inlet flow path and the other kind of fluid to a second inlet flow path. Supply parts 21, 31 (see FIG. 12) for supplying fluids to the inlet flow paths had a diameter of 0.5 mm.

### Fluid Supply Method

In supplying the fluids into the flow paths with the abovementioned pumps for supplying fluids, the two pumps were forced to absorb the first fluid and the second fluid respectively beforehand. At the beginning, the two pumps supplied the fluids at a velocity (flow rate) of 5 ml/min to avoid the air intrusion into the flow paths (remove remnant air), and then started supplying the fluids at desired velocity (flow rates). For observation of composite particles formed by electrostatic adsorption of the two kinds of particles, composite particles were collected about 10 seconds or more after the fluids started being supplied to the flow paths at predetermined velocities (flow rates).

### Experiment 1

### Experimental Flow Path 1

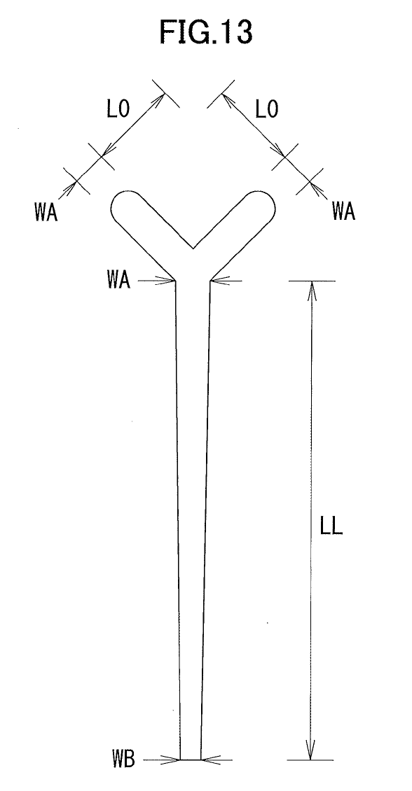

An acrylic plate member having a thickness of 2 mm was prepared for a flow path-forming substrate, and a flow path having a tapered shape as a whole, as shown in FIG. 13, was formed in accordance with the aforementioned procedures. The flow path produced in the acrylic plate was a through hole and had a depth of 2 mm, which was the same as a plate thickness. In a flow path structure of the drawing, a flow path width WA was 2 mm, a flow path width WB was 0.5 mm and an overall flow path length LL was 100 mm. Note that inlet flow paths had a flow path width WA of 2 mm, which was the same as the flow path width at a merging part of the mixing flow path, and each of the inlet paths had a length L0 of 10 mm.

### Comparative Example 1

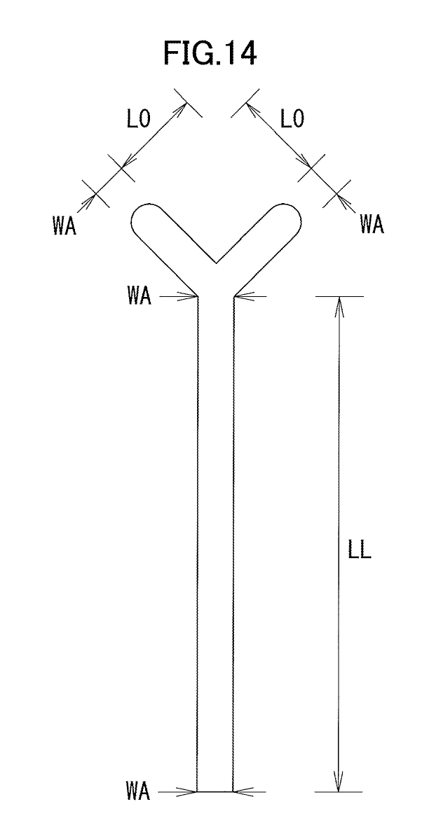

A comparative flow path having a uniform cross-sectional flow path area (flow path width) was produced for evaluating states of composite particles produced using the aforementioned tapered flow path. As shown in FIG. 14, a mixing flow path had a uniform cross-sectional flow path area (flow path width) and all the mixing flow path to an end had a uniform width WA. Others were the same as those of Experimental Flow Path.

### Experiment Results 1

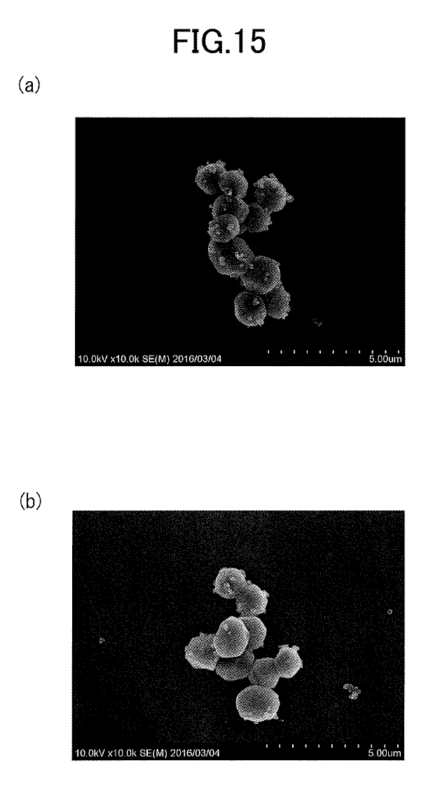

The first fluid and the second fluid prepared beforehand were supplied from inlet flow paths to these two flow paths, states of produced composite particles were confirmed by their SEM images. The SEM images are shown in FIG. 15. FIG. 15(a) shows composite particles produced using Experimental Flow Path 1, and FIG. 15(b) shows states of composite particles produced using the flow path of Comparative Example 1.

As is clear from the above comparison, in the composite particles produced using the flow path of Comparative Example 1, child particles adsorbed on mother particles are unevenly distributed. That is to say, composite particles in which a great number of child particles are adsorbed on one mother particle are mixed with composite particles in which a small number of child particles are adsorbed on one mother particle. In contrast, in the composite particles produced using Experimental Flow Path 1, almost the same number of child particles are adsorbed on any one of the mother particles, though the exact number of child particles was not counted.

The abovementioned experiment results demonstrate that two kinds of particles are adsorbed by each other while sufficiently dispersed by rendering a tapered flow path shape to a flow path structure, i.e., providing a flow path structure with a heterogeneous cross-sectional flow path area in a continuity direction thereof.

### Experiment 2

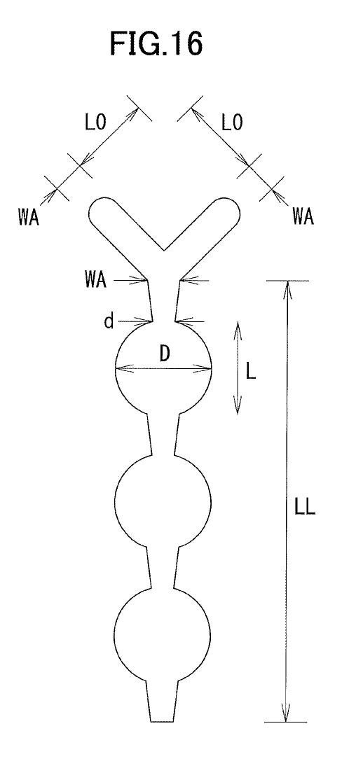

For a second experiment, an acrylic plate having a thickness of 2 mm was prepared for a flow path-forming substrate and taper-structured flow path parts and expansive-structured flow path parts shown in FIG. 16 were formed in accordance with the same procedures as above. In this case, too, a flow path was a through hole and had a depth of 2 mm, which was the same as the plate thickness. A great width part of each of the taper-structured flow path parts had a fixed flow path width WA of 2 mm. This flow path width WA was the same as a flow path width of an outlet part of each of the expansive-structured flow path parts. A small width part of each of the taper-structured flow path parts (an inlet part of each of the expansive-structured flow path parts) had a flow path width referred to as “d”, and the “d” was fixed at 1 mm. Note that a flow path length of each of the taper-structured flow path parts was given appropriately and that was about 5 mm in the experimental flow path.

Prior to the experiment, a simulation was carried out to determine a suitable ratio of a flow path width “D” and a flow path length “L” of a body part of each of the expansive-structured flow path parts in the abovementioned structure by using flow paths having plural kinds of shapes while changing numeral values of D and L. This simulation was to observe mixed states of the two kinds of fluids in the expansive-structured flow path parts, that is to say, to observe the mixed states when the fluid path width “D” and the fluid path length “L” of each of the expansive-structured flow path parts were appropriately changed on a basis of the abovementioned shape.

It was found out from results of the above simulation that upon controlling a ratio of a flow path width d of an inlet part to a flow path width D of a body part within the range of 1:3 to 1:7 in forming an expansive-structured flow path part, convection (an eddy flow) is caused to introduced fluids and the two kinds of fluids are suitably mixed. It was also found out that as for a ratio of the flow path width D and the flow path length L of the body part of each of the expansive-structured flow path parts, when the flow path length L is equal to or greater than D:L=1:1, there is no difference in mixed states of the fluids.

Based on the above simulation results, flow paths were produced in such a manner that a flow path length “L” was the same as a flow path width “D” (a ratio of L to D was 1:1) and the flow path width “D” and the flow path length “L” were changed within the range of 3 mm to 30 mm and an experiment of actually producing composite particles was carried out. Observation results of TEM images of composite particles produced in this experiment are shown in the table below.

TABLE 2

| | FLOW PATH WIDTH & LENGTH | | | | | |
|---|---|---|---|---|---|---|
| | 3 mm | 5 mm | 7 mm | 10 mm | 15 mm | 30 mm |
| OBSERVATION | Δ | ◯ | Δ | ▴ | X | X |
| RESULT | | | | | | |

◯: Child particles are dispersedly adsorbed on a plurality of mother particles.
Δ: Numbers of child particles adsorbed on a plurality of mother particles have a slight variation.
▴: Numbers of child particles adsorbed on a plurality of mother particles have a remarkable variation.
X: Numbers of child particles adsorbed on a plurality of mother particles have a great variation.

Judging totally from the above experiment, two kinds of particles can be dispersed with respect to each other and desired composite particles can be produced by rendering a flow path shape capable of changing a cross-sectional flow path area of a mixing flow path. Especially when the mixing flow path has an expansive-structured flow path part, preferred, more preferred and most preferred composite particles can be manufactured at a ratio of a flow path width of a body part and a flow path width of an inlet part being within the range of 1:3 to 1:10, within the range of 1:3 to 1:5 or at 1:5, respectively.

### REFERENCE SIGNS LIST

1 Device for Producing Composite Particles
2 First Inlet Flow Path
3 Second Inlet Flow Path
4 Merging Part
5 Mixing Flow Path
6 Outlet Port
7, 8 Mixing Region Units
11 Flow Path Substrate
12 Cover Part
21, 31 Supply Parts
50 Standard Flow Path Structure Part
51, 52, 53, 54 Taper-structured flow path parts
55, 56, 57 Expansive-structured flow path parts
58 Bulging Part (Variation of an Expansive-structured flow path part)
59 Protruding Part
A, B Particles
C Composite Particles

1-14. (canceled)

15. A device for manufacturing composite particles by mixing a first fluid containing particles having positive surface charge potential and a second fluid containing particles having negative surface charge potential and causing the two kinds of particles to electrostatically adsorb each other, comprising:
at least one first inlet flow path for supplying the first fluid; at least one second inlet flow path for supplying the second fluid; and a mixing flow path for merging the first fluid and the second fluid supplied respectively from the first inlet flow path and the second inlet flow path and allowing the two kinds of fluids to flow down for a predetermined length while mixing the two kinds of fluids;
the mixing flow path being a continuous flow path and having, in at least part of the entire mixing flow path, a velocity changing region for generating an eddy flow by making a stepwise, gradual or repeated change in velocity.

16. A device for manufacturing composite particles by mixing a first fluid containing particles having positive surface charge potential and a second fluid containing particles having negative surface charge potential and causing the two kinds of particles to electrostatically adsorb each other, comprising:
at least one first inlet flow path for supplying the first fluid; at least one second inlet flow path for supplying the second fluid; and a mixing flow path for merging the first fluid and the second fluid supplied respectively from the first inlet flow path and the second inlet flow path and allowing the two kinds of fluids to flow down for a predetermined length while mixing the two kinds of fluids;
the mixing flow path being a continuous flow path and having a heterogeneous cross-sectional flow path area in a continuity direction thereof for making a stepwise, gradual, or repeated change in velocity.

17. The device for manufacturing composite particles according to claim 16, wherein the mixing flow path has at least one taper-structured flow path part having a gradually or stepwise decreasing flow path cross-sectional area in a downstream direction.

18. The device for manufacturing composite particles according to claim 17, wherein the mixing flow path is constructed by a single taper-structured flow path part, and the taper-structured flow path part has a uniform depth and a tapered flow path width with an inclination of not less than 1.5/100.

19. The device for manufacturing composite particles according to claim 16, wherein the mixing flow path has at least one expansive-structured flow path part having an appropriate volume, and the expansive-structured flow path part comprises a body part, and an inlet part and an outlet part formed by opening the body part, and the body part has a larger cross-sectional flow path area than either of the inlet part and the outlet part.

20. The device for manufacturing composite particles according to claim 19, wherein the mixing flow path has a uniform depth, and the body part of the expanded flow path structure part is increased in cross-sectional area by being expanded in a width direction thereof.

21. The device for manufacturing composite particles according to claim 20, wherein the body part of the expansive-structured flow path part has wall surfaces in an arc shape.

22. The device for manufacturing composite particles according to claim 19, wherein one mixing region unit comprises at least one each of the taper-structured flow path part and the expanded flow path structure part, and the mixing flow path has at least one mixing region unit.

23. The device for manufacturing composite particles according to claim 22, wherein the mixing flow path has a standard flow path structure part having a predetermined flow path width, and the mixing region unit is provided in continuity with the standard flow path structure part.

24. The device for manufacturing composite particles according to claim 23, wherein the standard flow path structure part has a flow path width decreasing gradually or stepwise in a downstream direction from the predetermined flow path width.

25. The device for manufacturing composite particles according to claim 16, wherein each of the flow paths has a depth of not less than 1 mm and a flow path width of not less than 0.5 mm.

26. A method for manufacturing composite particles using the device for manufacturing composite particles according to claim 15, wherein the first fluid and the second fluid are supplied respectively to the first inlet flow path and the second inlet flow path at predetermined flow rates, and a ratio of one of the two kinds of particles adsorbed with respect to the other kind of particles is controlled by a ratio of the flow rates.

27. The method for manufacturing composite particles according to claim 26, wherein a relative ratio of a flow rate of the first fluid to be supplied to the first inlet flow path to a flow rate of the second fluid to be supplied to the second inlet flow path is controlled by a flow rate control step.

28. The method for manufacturing composite particles according to claim 26, wherein surface charges of the two kinds of particles contained respectively in the first fluid and the second fluid are controlled beforehand by an electric charge control step.
